(19) United States
(12) Patent Application Publication
(10) Pub. No.: US 2011/0267841 A1
(43) Pub. Date: Nov. 3, 2011

(54) DISPLAY APPARATUS

(76) Inventors: Myung-Woon Lee, Seoul (KR); Jung-Wook Paek, Suwon-si (KR); Taeseok Jang, Seoul (KR); Jinsung Choi, Cheonan-si (KR); Hyungguel Kim, Seongnam-si (KR); Sangduk Lee, Asan-si (KR); Taeho Lee, Seoul (KR)

(21) Appl. No.: 13/086,167

(22) Filed: Apr. 13, 2011

(30) Foreign Application Priority Data
Apr. 29, 2010 (KR) 10-2010-0040239

(51) Int. Cl. F21V 7/22

(52) U.S. Cl. 362/613

(57) ABSTRACT

Disclosed is a display apparatus. The display apparatus includes a light guide plate, a light source section, a light guide member, and a display panel. The light guide plate has a light incident surface and a light exit surface connected to the light incident surface. The light source section faces the light incident surface and has a plurality of light sources to output the light. The light guide member has a plate-like shape with first and second surfaces facing each other, in which the first surface contacts the light source section, and the second surface contacts the light incident surface, and guides light to the light guide plate. The display panel receives light output through the light exit surface to display an image.

### CROSS-REFERENCE TO RELATED APPLICATION

This application relies for priority upon Korean Patent Application No. 10-2010-0040239 filed on Apr. 29, 2010, the contents of which are herein incorporated by reference in their entirety.

### BACKGROUND OF THE INVENTION

1. Field of the Invention

The present invention relates to a display apparatus.

2. Description of the Related Art

A display apparatus such as a liquid crystal display or an electrophoretic display includes a display panel to display images. However, because the display panel is non-emissive, a backlight assembly is required to supply light to the display panel.

The backlight assembly includes a plurality of light sources that provide light. The light that is output from the light sources is partially lost when it reaches to the display panels. Accordingly, the amount of light incident onto the display panels is reduced compared to the initial output of light provided by the light sources.

### SUMMARY OF THE INVENTION

A display apparatus having superior light incidence efficiency from a light source to a display panel is provided.

In one aspect, the display apparatus includes a light guide plate, a light source section, a light guide member and a display panel.

The light guide plate has a light incident surface and a light exit surface connected to the light incident surface. The light source section has a plurality of light sources to output light, the light directed toward the light incident surface. The light guide member has a plate form with a first surface and a second surface facing the first surface, and guides the light to the light guide plate.

The first surface contacts the light source section, and the second surface contacts the light incident surface. The display panel displays an image by receiving light output through the light exit surface. The first surface has an area greater than or equal to an area of the second surface.

The light guide member may further include a first extending section protruding from the second surface and covering portions of two surfaces connected to the light incident surface. A thickness of the first extending section becomes smaller the farther the first extending section is away from the light incident surface.

A protrusion section projects from either the light incident surface or the second surface, and a recess section is provided in whichever of the light incident surface or the surface does not include the protrusion section. The recess section is positioned to correspond to the position of the protrusion section.

The light guide member may include a second extending section protruding from the first surface and covering at least one side of the light source section.

A plurality of light sources may be mounted on a printed circuit board. In this case, the light sources may protrude from a first surface of the printed circuit board. A plurality of recess sections are provided in the first surface of the light guide member. The recess sections are positioned to be in one-to-one correspondence with the positions of the light sources. The first surface of the light guide member contacts both portions of the first surface of the printed circuit board that are not covered by light sources and a surface of the light sources.

The light guide member includes a first layer that contacts the light source section and a second layer provided on the first layer. The second layer contacts the light guide plate.

As described above, a display apparatus including the light guide member to effectively guide light output from the light source section to the light guide plate is provided. In addition, misalignment of the light source section, the light guide member, and the light guide plate may be prevented to reduce light leakage.

Accordingly, the display apparatus provided herein has superior display quality by increasing the efficiency of light incidence to the display panel. In addition, the display apparatus is capable of lower power consumption because the number of the light sources can be reduced due to the superior light incidence efficiency.

### BRIEF DESCRIPTION OF THE DRAWINGS

FIG. 1 is an exploded perspective view showing a display apparatus according to an exemplary embodiment;

FIG. 2A is an exploded perspective view showing a portion of the display apparatus shown in FIG. 1;

FIG. 2B is a sectional view taken along line I-I′ of FIG. 2A;

FIG. 3A is an exploded perspective view showing a portion of a display apparatus according to an exemplary embodiment of the present invention;

FIG. 3B is a sectional view taken along line II-II′ of FIG. 3A;

FIG. 4A is an exploded perspective view showing a portion of a display apparatus according to an exemplary embodiment;

FIG. 4B is a sectional view taken along line III-III′ of FIG. 4A;

FIG. 5A is an exploded perspective view showing a part of a display apparatus according to an exemplary embodiment;

FIG. 5B is a sectional view taken along line IV-IV′ of FIG. 5A;

FIG. 6A is an exploded perspective view showing a part of a display apparatus according to an exemplary embodiment;

FIG. 6B is a sectional view taken along line V-V′ of FIG. 6A;

FIG. 7A is an exploded perspective view showing a portion of a display apparatus according to an exemplary embodiment;

FIG. 7B is a sectional view taken along line VI-VI′ of FIG. 7A;

FIG. 8A is an exploded perspective view showing a portion of a display apparatus according to an exemplary embodiment; and

FIG. 8B is a sectional view taken along line VII-VII′ of FIG. 8A.

### DESCRIPTION OF THE EMBODIMENTS

Hereinafter, various exemplary embodiments will be explained with reference to the accompanying drawings. However, the scope of the present invention is not limited to such embodiments and the present invention may be realized in various forms. In addition, the size of layers and regions shown in the drawings may be simplified or magnified for the purpose of clear explanation. Also, the same reference numerals are used to designate the same elements throughout the drawings.

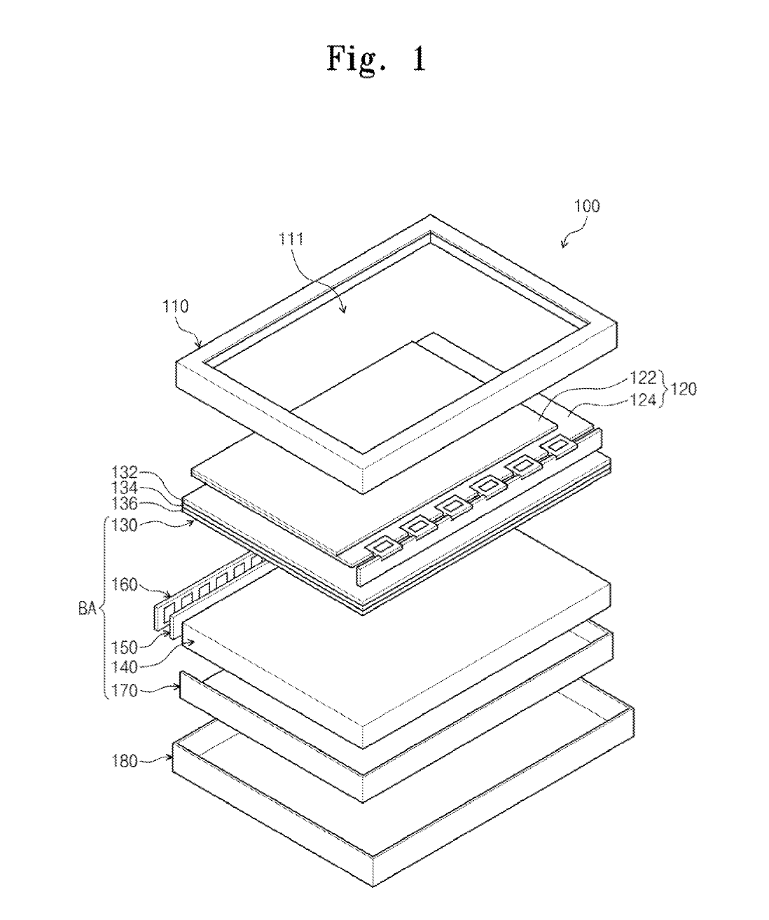

FIG. 1 is an exploded perspective view showing a display apparatus 100 according to an exemplary embodiment.

Referring to FIG. 1, the display apparatus 100 includes a backlight assembly BA, a display panel 120, a lower cover 180, and an upper cover 110.

The display panel 120 displays images. The display panel 120 may include various display panels such as, for example, a liquid crystal display panel or an electrophoretic display panel. According to the present embodiment, a liquid crystal display panel will be described as an example of the display panel 120.

The display panel 120 is prepared typically in the form of a rectangular plate having two longer sides and two shorter sides. The display panel 120 includes a first substrate 122, a second substrate 124 opposite to the first substrate 122, and a liquid crystal layer (not shown) interposed between the first and second substrates 122 and 124.

The first substrate 122 may include a plurality of pixel electrodes (not shown) and a plurality of thin film transistors (not shown) electrically connected to the pixel electrodes in one-to-one correspondence with the pixel electrodes. Each thin film transistor switches a driving signal to the corresponding pixel electrode. In addition, the substrate 124 may include a common electrode (not shown) to form an electric field together with the pixel electrodes, which is used to control the alignment of liquid crystal. The display panel 120 drives the liquid crystal layer to display an image at the front surface of first substrate 122 on display panel 120.

The upper cover 110 is provided at an upper portion of the display panel 120. The upper cover 110 supports the edges of a front surface of the display panel 120. A display window 111 is formed in the upper cover 110 to expose a display region of the display panel 120.

The backlight assembly BA is provided below the display panel 120, on the opposite side of the display panel 120 from the display region. The backlight assembly BA includes a light guide plate 140, a light source section 160, a light guide member 150, an optical member 130, and a reflective sheet 170.

The light guide plate 140 is provided in a plate-like shape, and is placed below the display panel 120.

The light source section 160 is adjacent to at least one side of the light guide plate 140. The light source section 160 supplies light, which is used by the display panel 120 to display images, to the light guide plate 140. The light guide plate 140 guides light emitted from the light source section 160 to the display panel 120.

The light guide member 150 is interposed between the light guide plate 140 and the light source section 160. The light guide member 150 guides light emitted from the light source section 160 to the light guide plate 140.

Additional description of the light source section 160, the light guide plate 140, and the light guide member 150 is provided below.

The optical member 130 is interposed between the light guide plate 140 and the display panel 120. The optical member 130 includes sheets which are used to control the quality of light that is provided to the display panel 120 from the backlight assembly BA. The light entering the optical member 130 is emitted from the light source section 160 and typically travels through the light guide member 150 and light guide plate 140 before entering the optical member 130. The optical member 130 includes a diffusion sheet 136, a prism sheet 134, and a protective sheet 132, which are typically stacked above the light guide plate in the sequence of the diffusion sheet 136 (on the bottom, closest to the light guide plate 140), the prism sheet 134 (in the middle), and the protective sheet 132 (on the prism sheet 134 and closest to the display panel 120).

The diffusion sheet 136 diffuses light emitted from the light source section 160. The prism sheet 134 concentrates the light, which has been diffused from the diffusion sheet 136, onto the plane of the display panel 120 in the direction perpendicular to the surface of display panel 120. Most of the light, which has passed through the prism sheet 134, is incident onto the display panel 120 in the direction perpendicular to the surface of the display panel 120. The protective sheet 132 is placed on the prism sheet 134. The protective sheet 132 protects the prism sheet 134 from external shock.

In the present exemplary embodiment, as described above, the optical member 130 includes the diffusion sheet 136, the prism sheet 134, and the protective sheet 132, each of which has a singular structure, but the present invention is not limited thereto. The diffusion sheet 136, the prism sheet 134, and/or the protective sheet 132 of optical member 130 may have a multiple-layer structure. In addition, if necessary, one or more of the diffusion sheet 136, the prism sheet 134, and the protective sheet 132 may be omitted.

The reflective sheet 170 is provided below the light source section 160, on the opposite side of the light guide plate 140 from the optical member 130 and on the lower cover 180. The reflective sheet 170 is provided to reflect any light that may have leaked from the light source section 160 or light guide plate 140, thereby redirecting the path of such leaked light back toward the display panel 120. The reflective sheet 170 includes a material to reflect light. As a result, the reflective sheet 170 increases the amount of light supplied to the display panel 120.

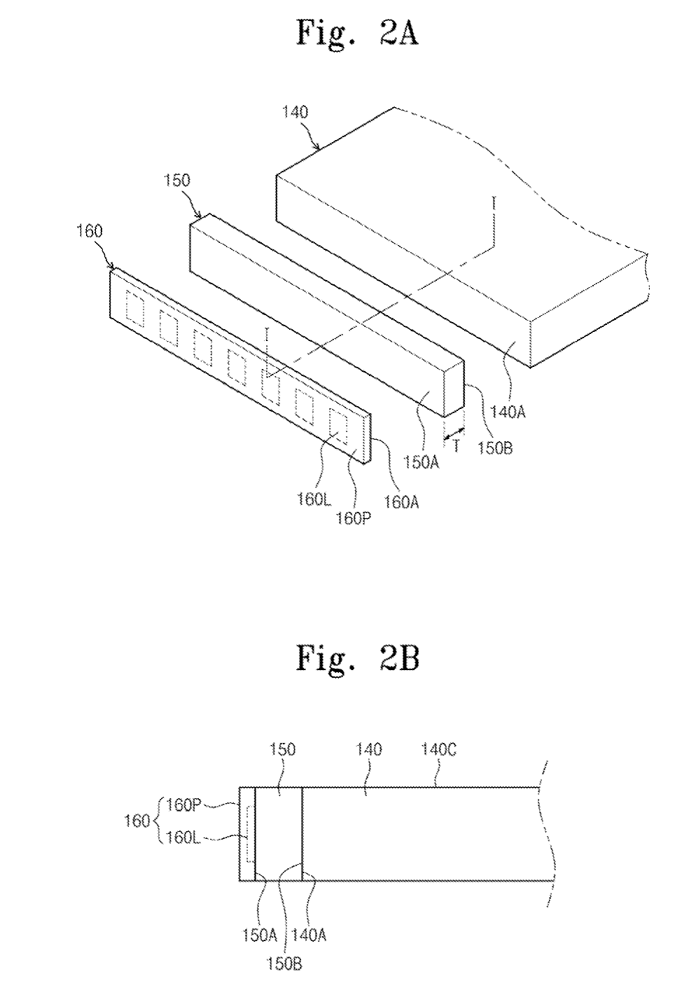

FIG. 2A is an exploded perspective view showing the light source section 160, the light guide member 150, and the light guide plate 140 of the display apparatus 100 shown in FIG. 1. FIG. 2B is a sectional view taken along line I-I′ of FIG. 2A. In particular, FIG. 2B is a sectional view showing the case in which the light source section 160, the light guide member 150, and the light guide plate 140 are assembled in the display apparatus 100.

Referring to FIGS. 2A and 2B, the light source section 160 is provided at one side of the light guide plate 140, and the light guide member 150 is provided between the light guide plate 140 and the light source section 160.

The light guide plate 140 is provided in the form of a rectangular plate. The two surfaces of the light guide plate 140 that have the widest area while facing each other are parallel to the display panel 120 in the assembled display apparatus 100.

The light guide plate 140 has a light incident surface 140A and a light exit surface 140C. The light incident surface 140A faces the light source section 160 and is defined as the lateral surface of the light guide plat 140 that (i) links the two surfaces of the light guide plate 140 having the widest area and (ii) which is also directly opposite to the light source section 160. Accordingly, the light emitted from the light source section 160 is incident into the light guide plate 140 through the light incident surface 140A.

The light exit surface 140C faces the display panel 120 and is the one of the two widest surfaces of the light guide plate 140 that is closest to the display panel 120. Light that has been incident into the light guide plate 140 is output to the display panel 120 through the light exit surface 140C.

The light incident surface 140A is connected to the light exit surface 140C in the display apparatus 100 according to the present exemplary embodiment, but the invention is not limited thereto. For example, the arrangement of light incident and exit surfaces may vary depending on the position of the light source section 160. If the light source section 160 is provided below the light guide plate 140 and the display panel 120, the light incident surface is provided in parallel to the light exit surface.

In addition, although one light incident surface is employed in the display apparatus 100 according to the present exemplary embodiment, the invention is not limited thereto. For example, a plurality of light source sections may be provided along the lateral surfaces of the light guide plate 140. In this case, a plurality of light incident surfaces may exist.

The light guide plate 140 may include transparent polymer resin such as, for example, polycarbonate or polymethyl methacrylate. The light guide plate 140 may have a refractive index in the range of about 1.4 to about 1.6.

The light source section 160 includes a printed circuit board 160P and a plurality of light sources 160L. The printed circuit board 160P is provided in a plate-like shape. The printed circuit board 160P has a size and a shape corresponding to the size and the shape of the light incident surface 140A and faces the light incident surface 140A of the light guide plate 140.

The light sources 160L are mounted on the printed circuit board 160P. A surface of the light sources 160L that faces the light incident surface 140A serves as an exit surface 160A through which light is emitted. Although, according to the present exemplary embodiment, the surface of the light sources 160L and the surface of the printed circuit board 160P are along the same plane, the invention is not limited thereto. For example, the light sources 160L may protrude from the surface of the printed circuit board 160P toward the light incident surface 140A.

The light sources 160L may include, for example, a light emitting diode LED.

The light guide member 150 has a plate-like shape with a first surface 150A and a second surface 150B facing the first surface 150A. The distance between the first and second surfaces 150A and 150B corresponds to a thickness T of the light guide member 150. The first surface 150A contacts the light source section 160. If the light sources 160L protrude from the printed circuit board 160P to the light guide member 150, the first surface 150A contacts the exit surface 160A. The second surface 150B contacts the light incident surface 140A of the light guide plate 140.

The light guide member 150 may include a transparent material having elasticity. The light guide member 150 may include polymer resin with heat resistance sufficient to prevent the light guide member 150 from being deformed due to heat emitted from the light sources 160L. For example, the light guide member 150 may include materials such as silicone, polycarbonate and polymethyl methacrylate. The light guide member 150 may be fabricated so that it has an adhesion property, and the first and second surfaces 150A and 150B of the light guide member 150 adhere to, respectively, the exit surface 160A and the light incident surface 140A. The adhesion property of the light guide member 150 may be improved by adjusting the adhesion degree of the polymer resin.

The light guide member 150 has a refractive index identical to or similar to that of the light guide plate 140. As the refractive index of the light guide member 150 approaches the refractive index of the light guide plate 140, the amount of light that is incident onto the light incident surface 140A from the light guide member 150 is increased. This is because the refraction degree of light and the frequency of light reflection are both decreased as the difference in the refractive index between materials forming the interfacial surface between the light guide member 150 and the light guide plate 140 is reduced. Accordingly, the light guide member 150 may have a refractive index in a range of values that is the same as or very similar to that of the light guide plate 140. For example, when the refractive index of the light guide plate 140 is in the range of about 1.4 to about 1.6, the light guide member 150 may have a refractive index in the range of about 1.4 to about 1.6.

The light guide member 150 typically has a transmissivity of about 80% or more. If the transmissivity of the light guide member 150 is less than about 80%, an amount of light supplied to the display panel 120 can be significantly reduced, so that image quality may be degraded.

The light guide member 150 may have predetermined hardness so that the predetermined degree of elasticity and adhesion property are obtained. According to an exemplary embodiment, the hardness of the light guide member 150 may be in the range of about shore A 40 to about shore A 80. If the hardness is less than about shore A 40, the light guide member 150 may be too easily extended. Accordingly, the light guide member 150 may not have a uniform thickness and a specific shape. If the hardness is greater than about shore A 80, the adhesion property between the light guide plate 140 and the light guide member 150 is so reduced that the light guide plate 140 and the light guide member 150 may be separated and may move individually with respect to each other.

The thickness T of the light guide member 150 may be in the range of about 0.5 mm to about 1.0 mm to ensure that the predetermined degree of elasticity of the light guide member 150 is obtained.

The light guide member 150 contacts the light source section 160 and the light guide plate 140 to minimize leakage of light from the light source section 160 by guiding light from the light source section 160 to the light guide plate 140.

Portions of light emitted from the light source section 160 may travel upward or downward through the area between the light source section 160 and the light guide plate 140, or may be reflected on the light incident surface 140A of the light guide plate 140. Such portions of light leak from the backlight assembly BA and, accordingly, the amount of light incident onto the light incident surface 140A of the light guide plate 140 is reduced. Specifically, the amount of light incident onto a light incident portion of the light guide plate 140 was measured at three distances, 0 mm, 0.5 mm, or 1.0 mm, between the light guide plate 140 and the light source section 160, in a state in which there was only a layer of air between the light guide plate 140 and the light source section 160. For measurements at all three distances the light guide plate 140 and the light source section 160 were maintained under the same condition. The results of the measurement were that at 0 mm, 0.5 mm, or 1.0 mm, about 0%, about 14.4%, or about 21.8%, respectively, of the light was lost. When, however, the light source section 160 came into close contact with the light guide plate 140 (i.e., when the distance between them was 0 mm) such that amount of light leakage was minimized, the light guide plate 140 and the light source section 160 were deformed due to the expansion or compression of the light guide plate 140 as a result of the heat emitted from the light source section 160.

However, according to an exemplary embodiment, the light source section 160 contacts the light guide member 150, so that the amount of light lost outside the light guide member 150 is minimized and is very small. Additionally, there is no, or only a very small, difference in the refractive indices between the light guide member 150 and the light guide plate 140, to minimize light reflection off of light incident surface 140A. Accordingly, most of the light that is incident onto the light guide member 150 is guided to the light guide plate 140 without light loss. Therefore, the amount of lost light is reduced due to the light guide member 150 as compared with a case in which only a layer of air exists between the light source section 160 and the light guide plate 140.

When the distance between the light source section 160 and the light guide plate 140 was about 1.1 mm, and the light guide member 150 was not included, the amount of light incident onto the light incident surface 140A was about 65 (relative value). When the distance between the light source section 160 and the light guide plate 140 was about 1.1 mm, but the light guide member 150 having a thickness T of 1.1 mm was interposed between the light source section 160 and the light guide plate 140, the amount of light incident onto the light incident surface 140A reached about 89 (relative value).

Because the light guide member 150 has elasticity, the light guide member 150 may absorb impact between the light guide plate 140 and the light source section 160 when the light guide plate 140 is expanded, compressed, or moved. Accordingly, any misalignment between the light source section 160 and the light guide plate 140 is reduced.

In addition, when manufacturing a backlight unit that includes the light guide member 150, the assembly efficiency is increased. The light source section 160 and the light guide plate 140 are easily arranged by using the light guide member 150 as described below. First, the light guide member 150 is prepared with protective sheets attached to the first and second surfaces 150A and 150B. Next, after removing the protective sheet from the second surface 150B of the light guide member 150, the second surface 150B is brought into contact with the light incident surface 140A of the light guide plate 140, such that there is no layer of air between the light incident surface 140A and the second surfaced 150B. Subsequently, after removing the protective sheet from the first surface 150A, the light source section 160 is brought into contact with the first surface 150A, such that there is no layer of air between the light incident surface 140A and the first surfaced 150A. Therefore, the light source section 160, the light guide member 150, and the light guide plate 140 can be simply and stably arranged.

Hereinafter, the additional various exemplary embodiments will be described by focusing on the differences from the above described exemplary embodiment in order to avoid redundancy. In addition, the same reference numbers will be used to refer to like elements.

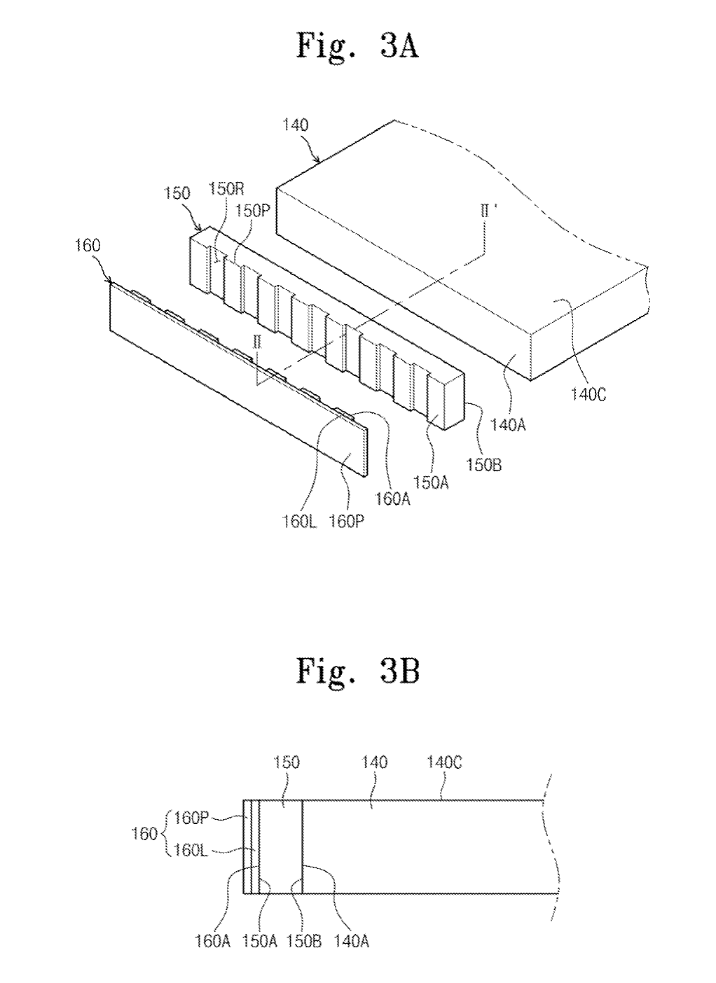

FIG. 3A is an exploded perspective view showing the light source section 160, the light guide member 150, and the light guide plate 140 provided in a display apparatus according an additional exemplary embodiment. FIG. 3B is a sectional view taken along line II-II′ of FIG. 3A. In particular, FIG. 3B is a sectional view showing the case in which the light source section 160, the light guide member 150, and the light guide plate 140 are assembled in the display apparatus.

Referring to FIGS. 3A and 3B, in the display apparatus according to the exemplary embodiment, the light source section 160 includes printed circuit board 160P and light sources 160L that are mounted on the printed circuit board 160P. The light sources 160L protrude from one surface of the printed circuit board 160P.

The light guide member 150 has a plate-like shape with the first surface 150A facing the second surface 150B.

A plurality of recess sections 150R are provided on the first surface 150A of the light guide member 150 in one-to-one correspondence with the light sources 160L. Hereinafter, the remaining portions of the first surface 150A, which are not the recess sections 150R, will be referred to as protrusion sections 150P because such remaining sections protrude toward the light source section 160 as compared with the recess sections 150R.

According to the exemplary embodiment illustrated in FIGS. 3A and 3B, when the light guide member 150 is coupled with the light source section 160, the light sources 160L are inserted into the recess sections 150R in one-to-one correspondence with the recess sections 150R. The remaining exposed surface of the printed circuit board 160P, which are the regions of the light source section 160 in which the light sources 160L are not mounted, corresponds to the protrusion sections 150P. Accordingly, the first surface 150A of the light guide member 150 contacts both the surfaces of the light sources 160L and the exposed surface of the printed circuit board 160P.

When the light sources 160L of the light source section 160 protrude from the printed circuit board 160P, the light output from the light sources 160L may leak through areas that are between adjacent light sources 160L. However, according to the present exemplary embodiment, when the light source section 160 is coupled with the light guide member 150, the whole regions including the protruding light sources 160L of the light source section 160 and recessed portions between the adjacent light sources 160L of the light source section 160 make contact with the light guide member 150. Accordingly, light leaking from the light sources 160L to the space between the adjacent light sources 160L is reduced.

Because the light guide member 150 contacts the light sources 160L, the light guide member 150 in the vicinity of the light sources 160L may be expanded or compressed due to heat emitted from the light sources 160L. The protrusion sections 150P of the light guide member 150 prevent the light guide member 150 and the light source section 160 from becoming mismatched due to the expansion or compression of the light guide member 150.

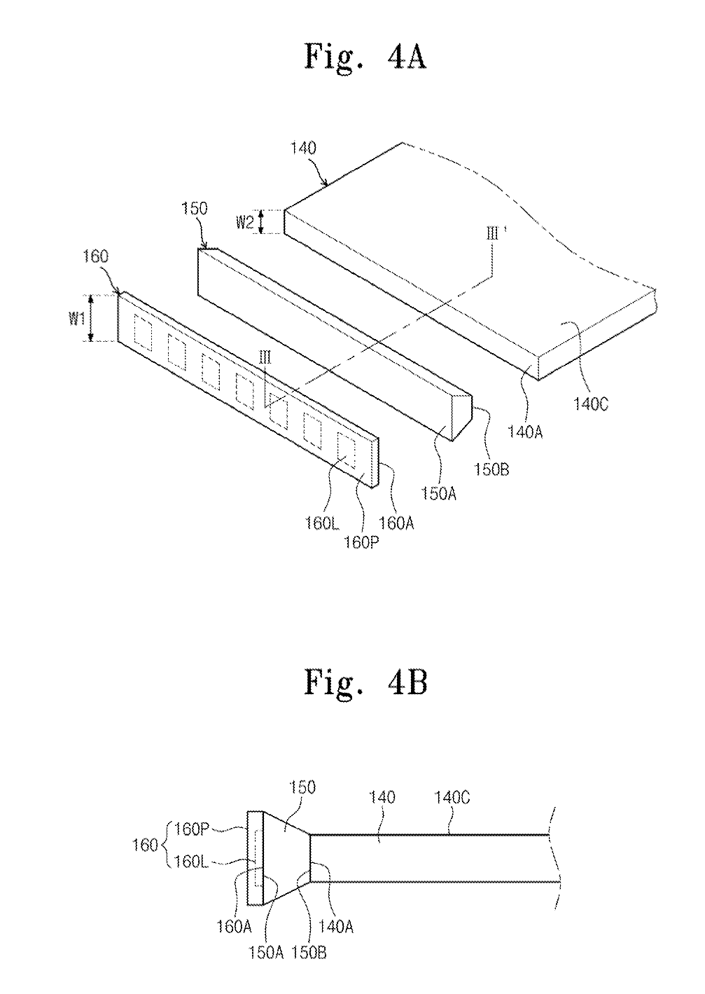

FIG. 4A is an exploded perspective view showing the light source section 160, the light guide member 150, and the light guide plate 140 provided in a display apparatus according to another exemplary embodiment. FIG. 4B is a sectional view taken along line III-III′ of FIG. 4A. In particular, FIG. 4B is a sectional view showing the case in which the light source section 160, the light guide member 150, and the light guide plate 140 are assembled in the display apparatus.

According to an exemplary embodiment, the light source section 160 may have various shapes or sizes. The light guide plate 140 may also have various shapes and sizes. In particular, in order to realize the display apparatus having a slim structure, the current is make the width of the light source section 160 and the light guide plate 140 as thin as possible. That is, the light source section 160 and the light guide plate 140 may have various widths according to the application. In this case, the width of the light source section 160 and the light guide plate 140 refers to a length thereof in a direction perpendicular to the image display surface of the display panel 120.

Referring to FIGS. 4A and 4B, a width W1 of the light source section 160 is less than a width W2 of the light guide plate 140, and the exit surface 160A of the light source section 160 has an area that is wider than that of the light incident surface 140A of the light guide plate 140.

The first surface 150A facing the exit surface 160A of the light source section 160 has a first area corresponding to the exit surface 160A to cover the exit surface 160A of the light source section 160 and makes contact with the exit surface 160A. The second surface 150B has a second area corresponding to the light incident surface 140A to cover the light incident surface 140A and makes contact with the light incident surface 140A. Therefore, the first surface 150A has an area that is greater than that of the second surface 150B.

Because the first surface 150A fully covers the exit surface 160A, light output from the light source section 160 is incident onto the light guide member 150 without light leakage. In addition, because the second surface 150B fully covers the light incident surface 140A, the light that has been incident onto the light guide member 150 is incident onto the light incident surface 140A without light leakage.

When facing surfaces of the light source section 160 and the light guide plate 140 have different areas, the size of the light guide member 150 is adjusted corresponding to an area exit surface 160A of the light source section 160 and an area of the light incident surface of the light guide plate 140. Although the present exemplary embodiment has been described with the area of the first surface 150A greater than the area of the second surface 150B, the present invention is not limited thereto. In other words, the area of the first surface 150A may be identical to or smaller than the area of the second surface 150B, depending on the areas of the exit surface 160A and light incident surface 140A that need to be matched.

In the present exemplary embodiment, the centers of the light source section 160 and the light guide plate 140 have the same height from the lower cover 180, so that the shape of light guide member 150 is symmetric about a center line between the light source section 160 and the light guide plate 140. However, embodiments of the present invention are not limited thereto. For instance, the position of the exit surface 160A from the lower cover 180 may be higher than or lower than the position of the light incident surface 140A from the lower cover 180. In this case, the first surface 150A and the second surface 150B may be arranged to correspond to the positions of the exit surface 160A and the light incident surface 140A, respectively, and the shape of the light guide member 150 modified accordingly.

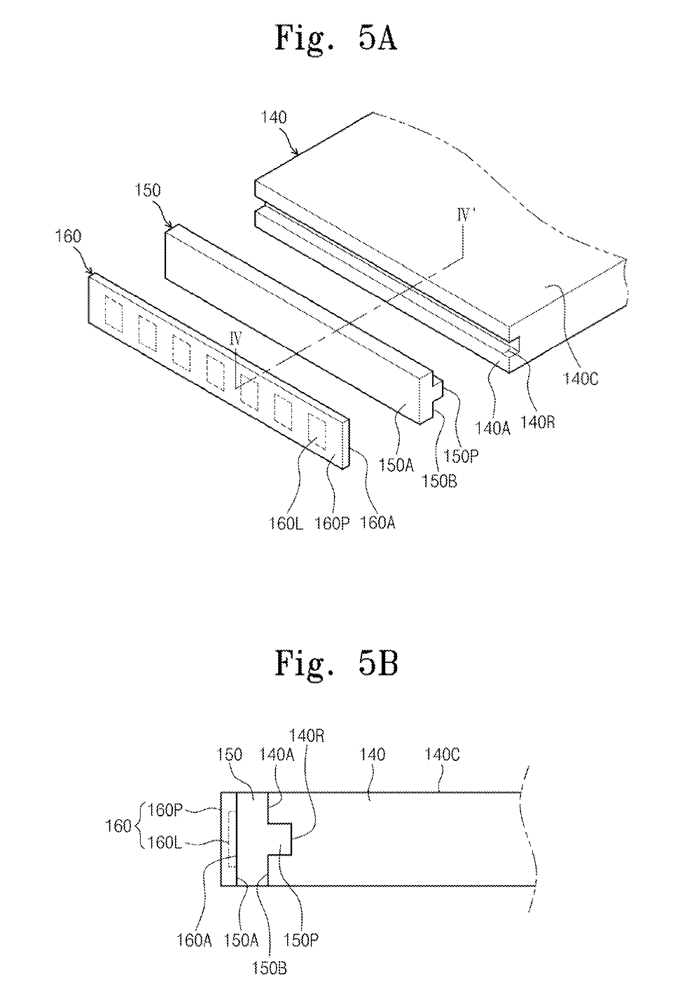

FIG. 5A is an exploded perspective view showing the light source section 160, the light guide member 150, and the light guide plate 140 provided in a display apparatus according to another exemplary embodiment. FIG. 5B is a sectional view taken along line IV-IV′ of FIG. 5A. In particular, FIG. 5B is a sectional view showing the case in which the light source section 160, the light guide member 150, and the light guide plate 140 are assembled in the display apparatus.

Referring to FIGS. 5A and 5B, the light guide member 150 includes a protrusion section 150P that protrudes from the second surface 150B. A recess section 140R corresponding to the protrusion section 150P is provided on the light incident surface 140A of the light guide plate 140. The protrusion section 150P has a shape inversely corresponding to the shape of the recess section 140R.

The light guide plate 140 and the light guide member 150 may become separated from each other due to the movement of the display apparatus. If the light guide plate 140 becomes separated from the light guide member 150, light leakage may occur due to the layer of air between the light guide plate 140 and the light guide member 150. It is desirable for the light guide plate 140 to be in contact with the light guide member 150 as much as possible such that a layer of air does not exist between the light guide plate 140 and the light guide member 150. The protrusion section 150P and the recess section 140R illustrated in FIGS. 5A and 5B are used to stably couple the light guide member 150 with the light guide plate 140 such that the light guide member 150 and the light guide plate 140 do not separate. According to the present exemplary embodiment, because the protrusion section 150P is inserted into the recess section 140R, the light guide member 150 may not become separated from the light guide plate 140.

The protrusion section 150P and the recess section 140R may have various shapes.

Although the light guide member 150 includes the protrusion section 150P according to the present exemplary embodiment, the present invention is not limited thereto. For example, a protrusion section may be formed on the light incident surface 140A of the light guide plate 140. In this case, a recess section is formed in the second surface 150B of the light guide member 150 corresponding to the protrusion section of the light guide plate 140.

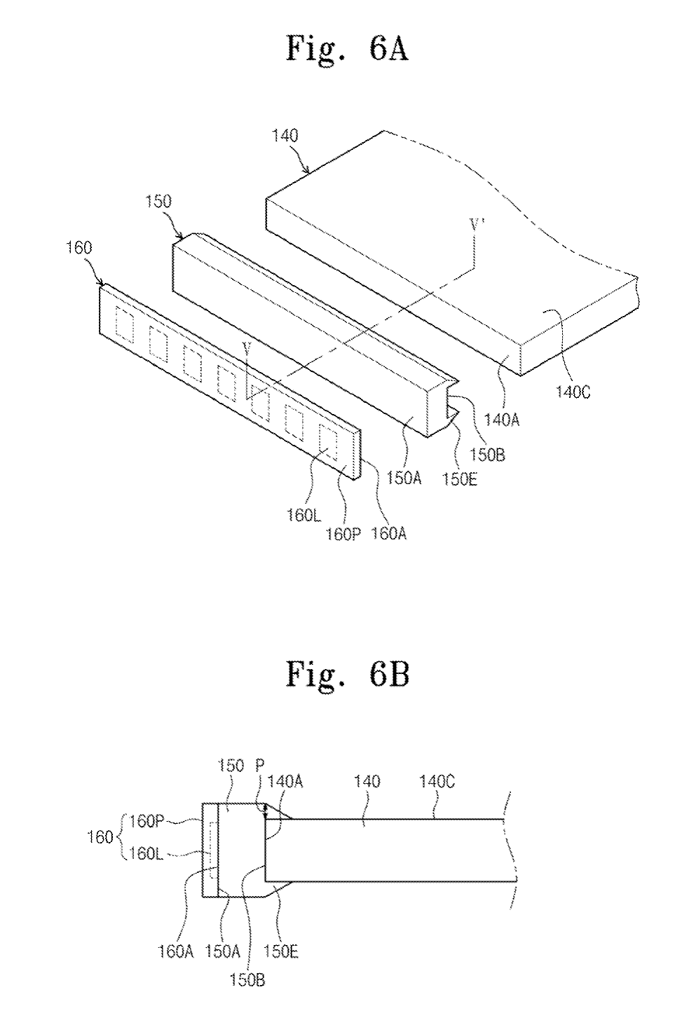

FIG. 6A is an exploded perspective view showing the light source section 160, the light guide member 150, and the light guide plate 140 provided in a display apparatus according to another exemplary embodiment. FIG. 6B is a sectional view taken along line V-V′ of FIG. 6A. In particular, FIG. 6B is a sectional view showing the case in which the light source section 160, the light guide member 150, and the light guide plate 140 are assembled in the display apparatus.

Referring to FIGS. 6A and 6B, the light guide member 150 has a first extending section 150E protruding from the second surface 150B. The first extending section 150E partially covers the two surfaces of the light guide plate 140, which face each other, adjoining the light incident surface 140A. The profile thickness P of the first extending section 150E is becomes smaller the farther the first extending section 150E is away from the light incident surface 140A.

As described above, the light guide plate 140 may become separated from the light guide member 150 due to the movement of the display apparatus. If the light guide plate 140 is separated from the light guide member 150, light leakage may occur due to the layer of air between the light guide plate 140 and the light guide member 150. The first extending section 150E is used to stably couple the light guide member 150 with the light guide plate 140.

Although, according to the present exemplary embodiment, the first extending section 150E partially covers the light exit surface 140C of the light guide plate 140 and also a surface facing the light exit surface 140C, the first extending section 150E may partially cover all four surfaces surrounding the light incident surface 140A according to another exemplary embodiment.

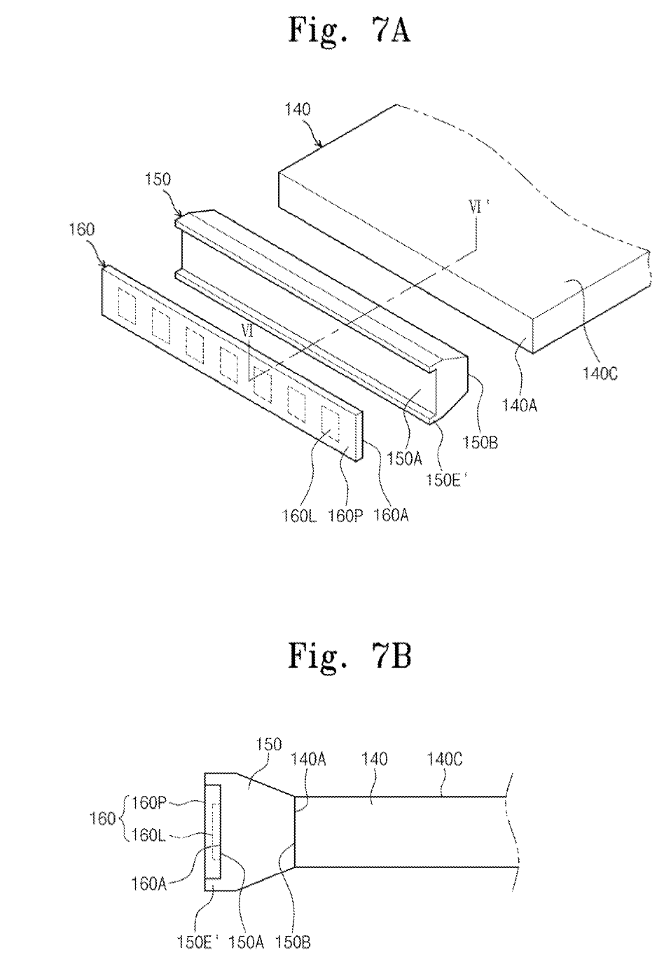

FIG. 7A is an exploded perspective view showing the light source section 160, the light guide member 150, and the light guide plate 140 provided in a display apparatus according to another exemplary embodiment. FIG. 7B is a sectional view taken along line VI-VI′ of FIG. 7A. In particular, FIG. 7B is a sectional view showing the case in which the light source section 160, the light guide member 150, and the light guide plate 140 are assembled in the display apparatus.

Referring to FIGS. 7A and 7B, the light guide member 150 has a second extending section 150E′ that protrudes from the first surface 150A. The second extending section 150E′ covers at least one side of the light source section 160.

The second extending section 150E′ is used to stably couple the light guide member 150 with the light source section 160. Otherwise, the light guide member 150 may become separated from the light source section 160 due to the movement of the display apparatus. If the light guide member 150 is separated from the light source section 160, the light guide member 150 and the light source section 160 may become misaligned, and light leakage may occur due to the layer of air between the light guide member 150 and the light source section 160.

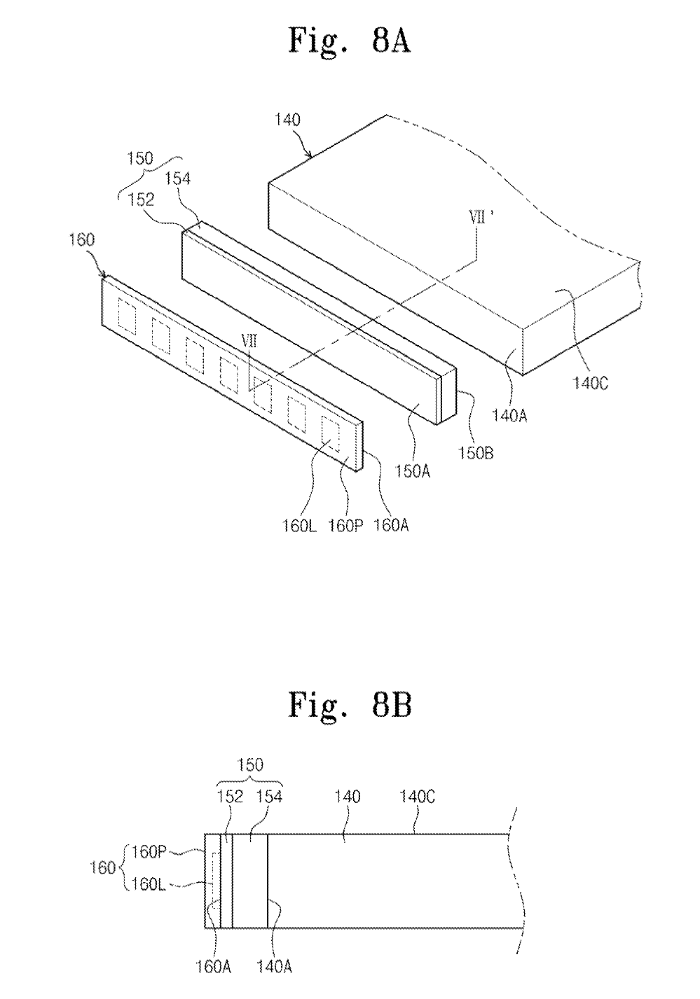

FIG. 8A is an exploded perspective view showing the light source section 160, the light guide member 150, and the light guide plate 140 provided in a display apparatus according to another exemplary. FIG. 8B is a sectional view taken along line VII-VII′ of FIG. 8A. In particular, FIG. 8B is a sectional view showing the case in which the light source section 160, the light guide member 150, and the light guide plate 140 are assembled in the display apparatus.

Referring to FIGS. 8A and 8B, the light guide member 150 has a double layer structure including a first layer 152 and a second layer 154.

The first layer 152 contacts the light source section 160. The second layer 154 is provided on the first layer 152 and contacts the light guide plate 140. The hardness of the first layer 152 is greater than that of the second layer 154. The hardness of the first layer 152 may be in the range of about shore A 70 to about shore A 80, and the hardness of the second layer 154 may be less than shore A 50.

When the light guide member 150 is formed in a double layer structure, the degree of adhesion between the light source section 160 and the light guide plate 140 can be variously adjusted. For example, if the light guide member 150 includes polymer resin, the hardness of the polymer resin is adjusted to control the degree of adhesion between the light guide member 150 and peripheral elements.

In the display apparatus, because the light guide member 150 may easily become misaligned with the light guide plate 140 due to the movement of the display apparatus, the adhesion property between the light guide member 150 and the light guide plate 140 must be increased to improve the light efficiency of the display apparatus.

Although the exemplary embodiments have been described, it is understood that the present invention should not be limited to these exemplary embodiments but various changes and modifications can be made by one ordinary skilled in the art within the spirit and scope of the present invention as described in the disclosure and hereinafter claimed.

What is claimed is:

1. A display apparatus comprising:
a light guide plate having a light incident surface and a light exit surface connected to the light incident surface;
a light source section having a plurality of light sources to output light, the light directed toward the light incident surface;
a light guide member having a plate-like shape with a first surface and a second surface facing the first surface, the first surface contacts the light source section and the second surface contacts the light incident surface to guide the light to the light guide plate; and
a display panel receiving light output through the light exit surface to display an image.

2. The display apparatus of claim 1, wherein the first surface has an area greater than or equal to an area of the second surface.

3. The display apparatus of claim 2, wherein the light guide member further comprises a first extending section protruding from the second surface and covering portions of two surfaces connected to the light incident surface.

4. The display apparatus of claim 3, wherein the first extending section has a thickness which is becomes smaller the farther the first extending section is away from the light incident surface.

5. The display apparatus of claim 2, wherein the second surface includes a protrusion section projecting from the second surface, and the light incident surface includes a recess section positioned to correspond to the position of to the protrusion section.

6. The display apparatus of claim 2, wherein the light guide member further comprises a second extending section protruding from the first surface and covering at least one side of the light source section.

7. The display apparatus of claim 1, wherein the light source section further comprises a printed circuit board on which the light sources are mounted.

8. The display apparatus of claim 7, wherein the light sources protrude from a first surface of the printed circuit board.

9. The display apparatus of claim 8, wherein the first surface of the light guide member includes a plurality of recess sections, and the recess sections are positioned to be in one-to-one correspondence with the positions of the light sources.

10. The display apparatus of claim 9, wherein the first surface of the light guide member contacts portions of the first surface of the printed circuit board that are not covered by the light sources and surfaces of the light sources.

11. The display apparatus of claim 1, wherein the light guide member comprises a first layer that contacts the light source section and a second layer provided on the first layer, the second layer contacts the light guide plate.

12. The display apparatus of claim 11, wherein the first layer has a hardness greater than a hardness of the second layer.

13. The display apparatus of claim 12, wherein the hardness of the first layer is in a range of about shore A 70 to about shore A 80, and the hardness of the second layer is less than shore A 50.

14. The display apparatus of claim 1, wherein the light guide member comprises silicone, polycarbonate, or polymethyl methacrylate.

15. The display apparatus of claim 14, wherein the light guide member has a refractive index in a range of about 1.4 to about 1.6.

16. The display apparatus of claim 15, wherein the light guide member has transmissivity in a range of about 80% to about 100%.

17. The display apparatus of claim 15, wherein the light guide plate has a refractive index in a range of about 1.4 to about 1.6.

18. The display apparatus of claim 15, wherein the light guide member has hardness in a range of about shore A 40 to about shore A 80.

19. The display apparatus of claim 1, wherein a shortest distance between the first surface and the second surface is in a range of about 0.5 mm to 1.0 mm.

20. A backlight assembly comprising:
a light guide plate having a light incident surface and a light exit surface connected to the light incident surface;
a light source section facing the light incident surface and having a plurality of light sources to output light; and
a light guide member having a plate-like shape with a first surface and a second surface facing the first surface, the first surface making contact with the light source section and the second surface making contact with the light incident surface to supply the light to the light guide plate.
